(19) United States
(12) Patent Application Publication
(10) Pub. No.: US 2003/0155682 A1
(43) Pub. Date: Aug. 21, 2003

(54) Method and apparatus for producing biodegradable, recessed molded receptacles

(75) Inventor: Thomas Koblitz, Dietersheim (DE)

Correspondence Address: FITZPATRICK CELLA HARPER & SCINTO, 30 ROCKEFELLER PLAZA, NEW YORK, NY, 10112, US

(73) Assignee: APACK Aktiengesellschaft fur biologische Verpackungen, Markt Erlbach (DE)

(21) Appl. No.: 10/225,351

(22) Filed: Aug. 22, 2002

Related U.S. Application Data
(63) Continuation of application No. PCT/EP01/01750, filed on Feb. 16, 2001.

(30) Foreign Application Priority Data
Feb. 22, 2000 (DE) 100 07 986.5

(51) Int. Cl. B29C 43/06

(52) U.S. Cl. 264/129; 264/297.7; 264/297.8; 425/408; 425/409

(57) ABSTRACT

Biodegradable, recessed molded receptacles (18) are produced by baking a baking composition between upper and lower baking molds (22, 24) in one baking operation to form a plurality of molded receptacles (18) in a coherent sheet structure (12) having an unbroken surface and containing the molded receptacles (18) which are subsequently separated from the sheet structure (12).

### CROSS REFERENCE TO RELATED APPLICATIONS

This is a Continuation of International Application PCT/EP01/01750 filed Feb. 16, 2001 which in turn claims priority of German application DE 100 07 986.5, filed Feb. 22, 2000, the priorities of which are hereby claimed, said International Application having been published in German, but not in English, as WO 01/62620 A1 on Aug. 30, 2001.

### BACKGROUND OF THE INVENTION

1. Field of the Invention

The invention is concerned with the production of biodegradable, recessed molded receptacles by baking a baking composition.

2. Description of the Related Art

The production of decomposable trays, beakers or other containers used for holding and optionally packaging foodstuffs, but also any desired other articles, by baking of a baking composition to form recessed molded receptacles is known, for example from WO 95/20628, WO 96/23026, WO 97/10293, DE 198 14 373 and DE 197 06 642. After baking, the molded receptacles are generally surface-treated before being stacked, packed and delivered. The surface treatment usually comprises the application of a coating which is to protect the molded receptacles from drying out or/and against the penetration of moisture or/and to render them more resistant to mechanical or chemical influences or/and to render them suitable for foodstuffs.

It is also known, in order to increase the yield, to bake the baking composition simultaneously between an upper and a lower baking mold in one baking operation to form a plurality of molded receptacles. If the molded receptacles are baked in isolated, disconnected form, it means a very high outlay in terms of handling to remove the individual molded receptacles from the baking molds, convey them to a subsequent coating station and coat them therein, especially when handling of the molded receptacles is carried out manually. This high outlay in terms of handling can have an adverse effect on throughput and hence on productivity when producing the molded receptacles.

### SUMMARY OF THE INVENTION

An object of the invention is accordingly to permit simpler handling of the baked molded receptacles.

In order to achieve that object, the invention starts from a process for the production of biodegradable, recessed molded receptacles by baking a baking composition, in which process the baking composition is baked simultaneously between an upper and a lower baking mold in one baking operation to form a plurality of molded receptacles. According to the invention, in order to produce the molded receptacles, the baking composition is baked between the two baking molds to form a coherent sheet structure which has an unbroken surface and contains the molded receptacles as an integral part, and the molded receptacles are then separated from the sheet structure.

The sheet structure is simpler to handle than a plurality of individual molded receptacles. That is true both for manual handling and for handling by machine. In general, the comparatively large sheet structure can be gripped more easily than a single, relatively small molded receptacle. In the case of handling by machine, this allows an automatic handling machine to be of more simple construction. In the case of manual handling in particular, the sheet structure additionally allows the baking molds to be emptied more rapidly, because a plurality of molded receptacles can be removed at once. This allows the baking rate to be increased, which in turn has a decisive influence on the overall cycle rate of a complete baking installation including subsequent processing stations, so that ultimately the productivity can be increased.

If the molded receptacles are formed in the sheet structure at a distance from the edge of the sheet on all sides, the edge region of the sheet structure located outside the molded receptacles can be used as the gripping region.

Depending on its composition, the baking composition may have a relatively viscous, in some cases even pasty consistency, particularly when it is mixed on the basis of cellulose fibres. Unlike a low-viscosity baking composition, there is the problem with such a viscous-to pasty baking composition that it will not spread out over the lower baking mold by itself. It has been found in practice, however, that it is possible to dispense with spreading of the baking composition before the baking molds are closed, and the desired spreading of the baking composition can instead be achieved solely by closing the two baking molds. It is then sufficient to apply the baking composition in a localized mound to the lower baking mold, which reduces the outlay required for applying the baking composition.

Although it is in principle possible to place a measured mound of baking composition into each of a plurality of molding cavities formed between the baking molds for the molded receptacles, in the course of the closing movement of the baking molds the baking composition can be distributed even into molding cavities which were initially not filled with baking composition. Accordingly, in a preferred further development of the invention, the baking composition is applied to the lower baking mold outside at least some of the molding cavities.

It may even suffice to apply the baking composition to the lower baking mold as individual mounds of composition.

If the two baking molds, for the purposes of closing, can be folded together relative to one another about a pivot axis, at least one mound of baking composition is advantageously applied to the lower baking mold offset eccentrically to the pivot axis. Since, in the course of the closing movement of the baking molds, that mound of composition is spread preferentially to the areas of the baking molds that are remote from the pivot axis, uniform distribution of the baking composition to all the molding cavities can be achieved.

If the molded receptacles are to be coated after baking, the sheet structure also offers advantages with regard to easier handling here too. It is therefore recommended to separate the molded receptacles from the sheet structure only after they have been coated at the surface with a coating material, especially a biodegradable coating material. In particular, for the coating of the molded receptacles, the coating material can be applied substantially to the entire surface of the sheet structure. The coating operation can be substantially facilitated as a result.

The invention relates also to a device for carrying out the process of the type described above. According to the invention, the device comprises two baking molds arranged one above the other, which, for baking of the sheet structure, can be transferred from a contact position, in which the baking molds form between them a plurality of molding cavities, closed to the outside, for the molded receptacles and rest flat against one another with contact surfaces, facing one another, around the molding cavities, by the development of pressure in the molding cavities, into a lifted-off position in which the baking molds are lifted from one another with the formation of a baking composition yield space between the contact surfaces.

When, the baking molds are in the contact position, only the molding cavities are present. In the contact position, the molding cavities are closed off to the outside; there is no communication between the molding cavities and the outside. When the baking composition introduced into the molding cavities is heated, a vapor pressure forms in the molding cavities. That pressure leads to the baking molds lifting off from one another. As they do so, the baking composition yield area forms between the contact surfaces of the baking molds, into which area the baking composition is able to penetrate from the molding cavities as it expands under the action of heat. The pressure between the molding cavities may optionally be equalized by way of the baking composition yield area. In the course of the baking operation, the baking composition yield area ultimately fills completely with baking composition; the sheet structure with the molded receptacles inserted therein in one piece is thus formed.

In order to be able to discharge to the outside at least some of the vapor pressure that forms in the baking composition yield space, the baking molds are advantageously assigned waste-steam channels which are blocked in the contact position and connect the baking composition yield space with the outside in the lifted-off position.

The waste-steam channels must be positioned at the baking molds with very great precision. Because the required position of the waste-steam channels may be different depending on the shape and size of the molded receptacles that are to be produced, but also depending on the properties and amount of the baking composition, it is recommended that the waste-steam channels be arranged at the baking molds in such a manner that their position relative thereto can be adjusted.

### BRIEF DESCRIPTION OF THE DRAWINGS

The invention is described in greater detail below with reference to the attached drawings.

FIG. 1 is a diagrammatic plan view of a baking installation with various stations;

FIG. 2 is a diagrammatic end elevational view, showing in open position, a pair of baking molds used in a baking station of the baking installation of FIG. 1;

FIG. 3 is an enlarged fragmentary view of the pair of baking molds of FIG. 2 in a closed or contact position;

FIG. 4 is a view taken along line IV-IV of FIG. 3, and showing a baking strip of the pair of baking molds;

FIG. 5 is a front elevational view of the baking strip of FIG. 4; and

FIG. 6 is a fragmentary section view showing a sheet structure, in a pair of baking molds, at a coating station following a baking station in the baking installation of FIG. 1.

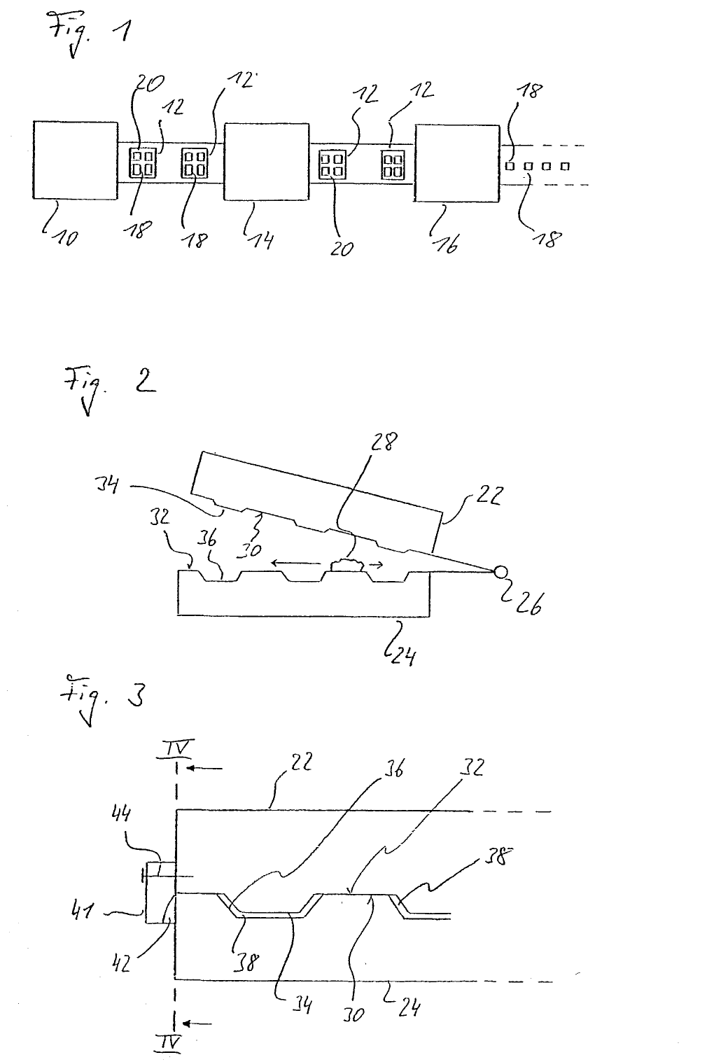

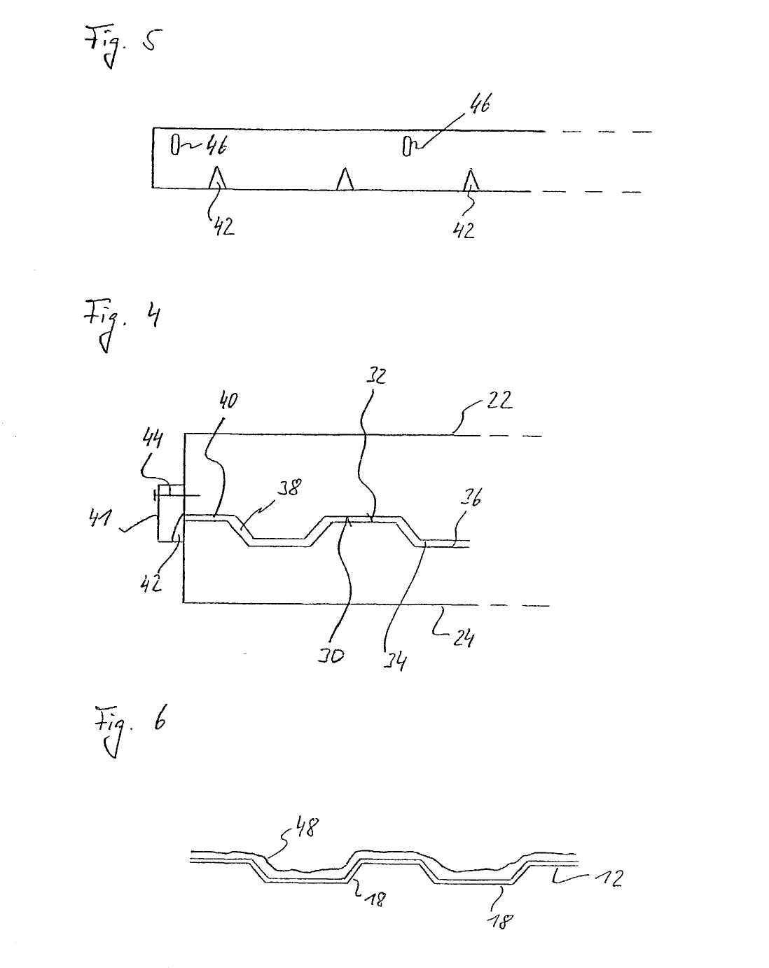

In FIG. 1, sheet structures 12 are baked at a baking station 10 and are coated at a subsequent coating station 14 and then transported to a separating station 16 where recessed molded receptacles 18, for example in the form of dishes, trays or beakers, are stamped out of the sheet structures 12. The molded bodies 18 are formed at the baking station 10 as an integral part of the sheet structures 12. Each sheet structure 12 has a plurality of such molded bodies 18, it being possible for the molded bodies 18 in each sheet structure 12 to be at a distance from one another or to be immediately adjacent to one another. The sheet structures 12 preferably have a circumferential edge region 20 which is left behind as cutting waste at the separating station 16 and facilitates gripping of the sheet structures 12. The baking station 10 may comprise, for example, a so-called automatic rotary cycle machine, in which several pairs of baking molds arranged one above another are arranged, distributed in the peripheral direction, on a rotary table and the rotary table is advanced in cycles. The pairs of baking molds pass in succession through a baking composition introduction region, a baking region and a sheet removal region, in which the baked sheet structures 12 are removed from the automatic rotary cycle machine. One or more sheet structures 12 can be baked in each pair of baking molds.

In FIG. 2, a pair of baking molds is shown diagrammatically. It comprises an upper baking mold 22 and a lower baking mold 24. The two baking molds 22, 24 are pivotably connected to one another by means of a hinge 26, the upper baking mold 22, for the introduction of the baking composition and for the removal of the baked sheet structures 12, being pivotable into an upward folded position and being folded down onto the lower baking mold 24 during the baking operation.

Within the scope of the invention there comes into consideration as the baking composition especially a relatively viscous dough based on cellulose fibres, which can be mixed, for example, by addition of starch and water. The molded bodies baked from that dough are biologically decomposable, so that they do not pollute the environment. They are used, for example, for the packaging of fresh foods, especially in the fast-food sector, but can also be used as containers for other articles, for example electrical or mechanical components. The viscosity of the dough does not allow it to be poured in an evenly distributed manner onto the lower baking mold 24 by means of a pouring strip, as is known, for example, in the preparation of edible waffles; it also prevents the dough from spreading out independently over the lower baking mold 24. Instead, a single mound of dough 28 is placed on the lower baking mold 24, in an area of the lower baking mold 24 close to the hinge 26. If the upper baking mold 22 is then folded down onto the lower baking mold 24, the mound of dough 28 is pressed flat, a larger amount of the mound of dough 28 spreading out to the areas of the baking molds 22, 24 that are remote from the hinge and only a smaller portion of the mound of dough 28 being forced in the direction towards the edge of the baking molds 22, 24 near to the hinge. That is the reason why the mound of dough 28 is applied to the lower baking mold 24 offset—relative to the center of the lower baking mold 24—eccentrically to the hinge 26.

In planar contact surfaces 30, 32, facing one another, of the two baking molds 22, 24, opposing mold elevations 34 and mold depressions 36 are formed. Once the mound of dough 28 has been placed onto the lower baking mold 24, the upper baking mold 22 is first folded down onto the lower baking mold 24 into a contact position in which the baking molds 22, 24 rest against one another with their contact surfaces 30, 32 and the mold elevations 34 extend into the mold depressions 36. Molding cavities 38 are thus formed between the mold elevations 34 and the mold depressions 36, which cavities 38 are, for example, dish-, tray- or beaker-shaped according to the molded bodies 18 to be baked. As a result of the closing movement of the baking molds 22, 24, the baking dough applied to the lower baking mold 24 is distributed evenly into all the molding cavities 38. Accordingly, when the baking molds 22, 24 are in the contact position, baking dough is located only in the molding cavities 38 but not between the contact surfaces 30, 32. The molding cavities 38 do not communicate with the outside when the baking molds 22, 24 are in the contact position, because the contact surfaces 30, 32 are in flat circumferential contact with one another at least in the edge region of the baking molds 22, 24. Waste-steam channels, which lead from the molding cavities 38 to the outside, are not present. Provided the molding cavities 38 are not connected with one another, the contact surfaces 30, 32 of the baking molds 22, 24 in the contact position rest against one another even around each of the molding cavities 38, so that each molding cavity 38 is closed on all sides. This situation is shown in FIG. 3.

When the closed baking molds 22, 24 according to FIG. 3 are transferred to the baking region of the baking station 10, a vapor pressure builds up in the molding cavities 38 by evaporation of the liquid contained in the baking dough, which vapor pressure is at first unable to escape from the molding cavities 38. As a result of the rise in pressure in the molding cavities 38, the upper baking mold 22 lifts off from the lower baking mold 24 slightly, with the formation between the contact surfaces 30, 32 of a baking composition yield space 40 in communication with the molding cavities 38. It will be understood that stop means, which are not shown in greater detail, will limit the lifting height of the upper baking mold 22. It will additionally be understood that suitable vertical guide means will be provided, which permit a guided lifting movement of the upper baking mold 22. The baking dough in the molding cavities 38, which expands porously as a result of the action of heat and the formation of steam during the baking operation, spreads out in the baking composition yield space 40 and ultimately fills it completely. As a result, there is formed a continuous sheet structure having a closed surface and a plurality of, for example, dish-, tray- or beaker-shaped regions which are later stamped out of the sheet structure at the separating station 16 and form the molded bodies 18.

A baking strip 41 is attached to at least one of the lateral edges of the upper baking mold 22, which baking strip 41 overlaps the lower baking mold 24 when the baking molds 22, 24 are in the closed state and ensures that the edges of the lower baking mold 24 are sealed with respect to the upper baking mold 22. A plurality of waste-steam channels 42 are incorporated into the baking strip 41 at regular intervals, through which channels the steam emerging from the baking dough is able to escape to the outside when the baking molds 22, 24 are in the lifted-off position. When the baking molds 22, 24 are in the contact position, the waste-steam channels 42 are blocked, while in the lifted-off position of the baking molds 22, 24 they connect the baking composition yield space 40 with the outside. During the baking operation, a small amount of baking composition also passes into the waste-steam channels 42 when the baking molds 22, 24 are in the lifted-off position. That baking composition forms plugs in the waste-steam channels 42. Those plugs dry and thus close off the waste-steam channels 42 again after part of the baking operation. The baking operation is then completed with the waste-steam channels 42 closed.

In FIG. 5, it will be seen that the waste-steam channels 42 in the embodiment described herein are in the form of triangular indentations which are incorporated into the side of the baking strip 41 remote from the baking molds 22, 24. FIG. 3 additionally shows that the waste-steam channels 42 have a depth which increases from the tip of the triangle to its base. This form of the waste-steam channels 42 has the effect that their cross-section increases continuously from the tip of the triangle to its base (approximately pyramidally). By placing the baking strip 41 in different positions relative to the upper baking mold 22, it is possible to influence the effective cross-sectional through-profile offered by the waste-steam channels 42 for the steam emerging from the baking composition yield space 40. It has been found that time-consuming tests are sometimes required in order to determine the optimum position of the baking strip 41. The approximately pyramidal form of the waste-steam channels 42 permits very fine variations in the effective cross-sectional through-profile of the waste-steam channels 42 down to very small through-cross sections.

The baking strip 41 is fastened to the side of the upper baking mold 22 by means of screws 44 which pass through elongated holes 46 formed in the strip 41. The elongated holes 46 allow adjustment of the height of the baking strip 41 relative to the upper baking mold 22.

After baking of the sheets, the sheet structures 12 leaving the baking station 10 are deburred and then coated in the coating station 14 with a material which is likewise biodegradable. In FIG. 6, it will be seen that the sheet structures 12 are each coated as a whole sheet, the coating being carried out either on one side or on both sides. The coating of sheets offers considerable handling advantages as compared with the individual coating of each individual molded body 18. There may be used as the coating material, for example, a film 48 which is applied to the surface of each sheet structure 12 by vacuum suction. Of course, the film 48 may also be applied to the sheet structure 12 by hot stamping. Alternatively, it is conceivable to spray the entire surface of the sheet structure 12 with a coating material. The molded bodies 18 are not stamped out of the sheet structure 12 until the coating operation is complete. The residue of sheet structure that remains is transported away as waste.

The sheet structure 12 that is produced is dimensionally stable overall, so that it substantially does not distort during subsequent handling. It thus exhibits an inherent stiffness, which is ensured by the connection between the individual receptacles over the entire surface. The thickness of the material of the connecting surfaces between the receptacles can be chosen, for example, to correspond approximately to the thickness of the walls of the receptacles themselves. That wall thickness is conventionally several millimeters.

1. A process for producing biodegradable, recessed molded receptacle, said process comprising the steps of:
baking a baking composition between upper and lower baking molds to form, in one baking operation, a plurality of molded receptacles formed in a coherent sheet structure which has an unbroken surface and which contains the molded receptacles as an integral part; and
separating said molded receptacles from said sheet structure.

2. A process according to claim 1, wherein:
said molded receptacles are formed in the sheet structure at a distance from the edges of said sheet structure on all sides thereof.

3. A process according to claim 1 or 2, wherein
said baking composition is viscous-to-pasty and comprises principally cellulose fibers, and wherein
said baking composition is applied as a localized mound on the lower baking mold and is distributed by closing on the molds.

4. A process according to claim 3, wherein
said baking molds form between them a plurality of molding cavities for forming the molded receptacles, and wherein
the baking composition is applied on the lower baking mold outside of at least some of the molding cavities.

5. A process according to claim 4, wherein
said baking composition is applied on the lower baking mold in the form of a single mound of composition.

6. A process according to one of claims 4-5, wherein
said upper and lower baking molds are closed by folding them together about a pivot axis, and wherein
at least one mound of baking composition is applied on the lower baking mold at a location which is offset eccentrically to said pivot axis.

7. A process according to one of claims 6, wherein
said molded receptacles are coated on their surface with a biodegradable coating material before they are separated from said sheet structure.

8. A process according to claim 7, wherein
said coating material is applied to substantially the whole surface of said sheet structure.

9. A device for forming biodegradable recessed molded receptacles, said device comprising:
two baking molds arranged one above the other for baking a sheet structure, said molds being transferable from a contact position in which they form between them a plurality of receptacle forming cavities which are closed to the outside and which rest flat against one another with contact surfaces facing one another, around the cavities, to a lifted-off position in which the baking molds are lifted from one another with the formation of a baking composition yield space between the contact surfaces.

10. A device according to claim 9, wherein
waste-steam channels are provided in said baking molds, said waste-steam channels in said contact position of said baking molds being blocked, and said waste-steam channels in the lifted-off position of said molds being connected between said baking composition yield space and the outside.

11. A device according to claim 10, wherein
said waste-steam channels are arranged on the baking molds such that their position relative thereto can be adjusted.
